(19) United States
(12) Patent Application Publication
(10) Pub. No.: US 2024/0108005 A1
(43) Pub. Date: Apr. 4, 2024

(54) PESTICIDAL COMPOSITION

(71) Applicant: SUMITOMO CHEMICAL COMPANY, LIMITED, Chuo-ku (JP)

(72) Inventor: Takuya TANAKA, Chuo-ku (JP)

(73) Assignee: SUMITOMO CHEMICAL COMPANY, LIMITED, Chuo-ku (JP)

(21) Appl. No.: 18/255,080

(22) PCT Filed: Nov. 30, 2021
(86) PCT No.: PCT/JP2021/043755

§ 371 Date: May 30, 2023

(30) Foreign Application Priority Data
Dec. 1, 2020 (JP) 2020-199857

(51) Int. Cl. A01N 43/54; A01N 25/04; A01N 37/40; A01P 13/00

(52) U.S. Cl. CPC A01N 43/54; A01N 25/04; A01N 37/40; A01P 13/00

(57) ABSTRACT

Provided is a pesticidal composition comprising a compound represented by the formula (I), a herbicidal active salt, an organic solvent having a water solubility at 25° C. of 10 mass % or less, a surfactant and water, wherein a weight ratio between the compound represented by the formula (I) and the surfactant is 1:10 or more and 1:50 or less.

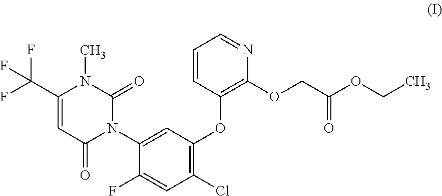 [SMILES: CCOC(=O)COc1ncccc1Oc1cc(-n2c(=O)cc(C(F)(F)F)n(C)c2=O)c(F)cc1Cl]

### TECHNICAL FIELD

The present invention relates to a pesticidal composition.

### BACKGROUND ART

A compound represented by the following formula (I), which is an active ingredient for herbicides, is known as a pesticidal active compound (see, e.g., U.S. Pat. No. 6,537,948 (Patent Literature 1)).

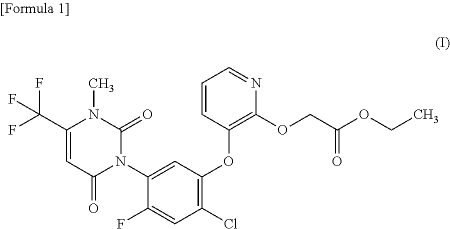 [SMILES: CCOC(=O)COc1ncccc1Oc1cc(-n2c(=O)cc(C(F)(F)F)n(C)c2=O)c(F)cc1Cl]

### CITATION LIST

### Patent Literature

PTL 1: U.S. Pat. No. 6,537,948

### SUMMARY OF INVENTION

### Technical Problem

An object of the present invention is to provide a liquid pesticidal composition comprising a compound represented by the formula (I) and a herbicidal active salt, wherein the liquid pesticidal composition exhibits excellent herbicidal activity.

### Solution to Problem

The present invention provides the following pesticidal composition.
[1] A pesticidal composition comprising a compound represented by the formula (I), a herbicidal active salt, an organic solvent having a water solubility at 25° C. of 10 mass % or less, a surfactant and water, wherein a weight ratio between the compound represented by the formula (I) and the surfactant is 1:10 or more and 1:50 or less:

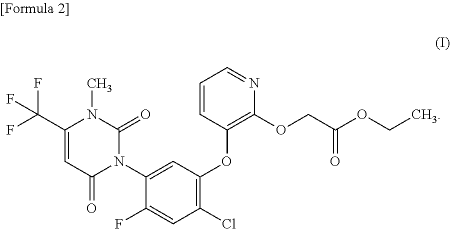 [SMILES: CCOC(=O)COc1ncccc1Oc1cc(-n2c(=O)cc(C(F)(F)F)n(C)c2=O)c(F)cc1Cl]

[2] The pesticidal composition according to [1], wherein the surfactant comprises a nonionic surfactant.
[3] The pesticidal composition according to [1] or [2], wherein the organic solvent comprises an aromatic hydrocarbon.
[4] The pesticidal composition according to any of [1] to [3], wherein the herbicidal active salt comprises a herbicidal active carboxylate.
[5] The pesticidal composition according to any of [1] to [3], wherein the herbicidal active salt comprises one or more herbicidal active salts selected from the group consisting of a herbicidal active benzoate and a herbicidal active phenoxyacetate.
[6] The pesticidal composition according to any of [1] to [3], wherein the herbicidal active salt comprises one or more herbicidal active salts selected from the group consisting of a dicamba salt and a 2,4-D salt.
[7] The pesticidal composition according to any of [1] to [3], wherein the herbicidal active salt comprises a dicamba salt.
[8] The pesticidal composition according to any of [1] to [3], wherein the herbicidal active salt comprises dicamba diglycolamine.
[9] The pesticidal composition according to any of [1] to [8], wherein the pesticidal composition contains an aqueous phase and particles of an oil phase dispersed in the aqueous phase, wherein
the oil phase contains the organic solvent and the compound represented by the formula (I) dissolved in the organic solvent.
[10] The pesticidal composition according to [9], wherein a volume median diameter of the particles of the oil phase is 1 nm or larger and smaller than 100 nm.
[11] The pesticidal composition according to any of [1] to [10], wherein T₂₀ is 500 or less, wherein
T₂₀ refers to a time (ms) required for a surface tension at 20° C. measured by a maximum bubble pressure method of a liquid that is the pesticidal composition diluted with water (0.01 mass % as a concentration of the compound represented by the formula (I)) to decrease from 72.80 mN/m to 52.80 mN/m.

### Advantageous Effects of Invention

It is made possible to provide a liquid pesticidal composition comprising a compound represented by the formula (I) and a herbicidal active salt, wherein the liquid pesticidal composition exhibits excellent herbicidal activity.

### DESCRIPTION OF EMBODIMENTS

A pesticidal composition according to the present invention (hereinafter, also simply called “pesticidal composition”) contains a compound represented by the formula (I) (hereinafter, also called “compound (I)”), a herbicidal active salt, an organic solvent having a water solubility at 25° C. of 10 mass % or less (hereinafter, also called “organic solvent A”), a surfactant and water. The pesticidal composition is usually an oil-in-water microemulsion containing an aqueous phase and particles of an oil phase solubilized in a micelle of a surfactant (also called swollen micelle), the particles being dispersed in the aqueous phase. The oil phase contains the organic solvent A and the compound (I) dissolved in the organic solvent A.

In the following, a detailed description will be given of ingredients that the pesticidal composition contains or may contain.

[1] Pesticidal Active Compound

The pesticidal composition contains a compound (I) as a first pesticidal active compound. In the pesticidal composition, the compound (I) is contained in the oil phase and dissolved in the organic solvent A constituting the oil phase.

With the total amount of the pesticidal composition being taken as 100 mass %, the content of the compound (I) in the pesticidal composition is preferably 0.01 mass % or more and 25 mass % or less, more preferably 0.05 mass % or more and 20 mass % or less, further preferably 0.1 mass % or more and 15 mass % or less, yet further preferably 0.2 mass % or more and 10 mass % or less, in view of moderately raising the content and improving the storage stability of the pesticidal composition.

The pesticidal composition contains one, two, or more herbicidal active salts as a second pesticidal active compound. Usually, the aqueous phase contains the herbicidal active salt(s). The herbicidal active salt is a herbicidal active compound in a salt form, and examples thereof include herbicidal active carboxylates, herbicidal active thiocarbonates, herbicidal active sulfonates, herbicidal active sulfinates, herbicidal active thiosulfonates and herbicidal active phosphites. The herbicidal active salt is preferably a herbicidal active carboxylate. A portion of the herbicidal active salt may be present in a neutral state in the pesticidal composition. For example, when the herbicidal active salt is a herbicidal active carboxylate, the carboxylate group (—COO⁻ group) of the salt may be present in equilibrium with a carboxy group (—COOH group).

Examples of the herbicidal active salt include herbicidal active carboxylates, herbicidal active thiocarbonates, herbicidal active sulfonates, herbicidal active sulfinates, herbicidal active thiosulfonates and herbicidal active phosphites listed in The Pesticide Manual Fifteenth Edition (2009), British Crop Production Council (ISBN: 978-1-901396-18-8), and examples of the herbicidal active carboxylate include the following:

herbicidal active benzoates such as diflufenzopyr salt, naptalam salt, dicamba salt, and 2,3,6-trichlorobenzoic acid (2,3,6-TBA) salt;

herbicidal active pyrimidinyloxybenzoates such as bispyribac sodium;

herbicidal active pyrimidinylthiobenzoates such as pyrithiobac sodium;

herbicidal active picolinates such as aminopyralid salt, clopyralid salt, and picloram salt;

herbicidal active aromatic acid salts such as aminocyclopyrachlor salt and imazethapyr salts (e.g., imazethapyr ammonium);

herbicidal active phenoxyacetates such as (2,4-dichlorophenoxy)acetic acid (2,4-D) salt, MCPA (4-(4-chloro-o-tolyloxy)acetic acid) salt, and (2,4,5-trichlorophenoxy)acetic acid (2,4,5-T) salt;

herbicidal active phenoxybutyrates such as 4-(2,4-dichlorophenoxy)butyric acid (2,4-DB) salt and 4-(4-chloro-o-tolyloxy) butyric acid (MCPB) salt;

herbicidal active phenoxypropionates such as dichlorprop salt, dichlorprop-P salt, fenoprop salt, mecoprop salt, and mecoprop-P salt; and

herbicidal active salts classified into carboxylic acid-containing organophosphorus herbicides such as glufosinate ammonium, glufosinate-P ammonium, and glyphosate salts (e.g., glyphosate potassium, glyphosate dimethylamine, glyphosate monoethanolamine, and glyphosate isopropylammonium).

The herbicidal active salt is preferably a herbicidal active carboxylate, is more preferably one or more selected from herbicidal active benzoates and herbicidal active phenoxyacetates, and is further preferably one or more selected from dicamba salts and 2,4-D salts.

Examples of the dicamba salt include dicamba diglycolamine, dicamba tetrabutylamine, dicamba tetrabutylphosphonium and dicamba N,N-bis(3-aminopropyl)methylamine (BAPMA), with dicamba diglycolamine being preferable. The pesticidal composition can contain one, two, or more dicamba salts.

Examples of the 2,4-D salt include 2,4-D ammonium, 2,4-D diethylammonium, 2,4-D dimethylammonium, 2,4-D diolamine, 2,4-D dodecylammonium, 2,4-D heptylammonium, 2,4-D isopropylammonium, 2,4-D lithium, 2,4-D sodium, 2,4-D tetradecylammonium, 2,4-D triethylammonium, 2,4-D tris(2-hydroxypropyl)ammonium, 2,4-D trolamine, and 2,4-D choline. The pesticidal composition can contain one, two, or more 2,4-D salts.

With the total amount of the pesticidal composition being taken as 100 mass %, the content of the herbicidal active salt in the pesticidal composition is preferably 0.1 mass % or more and 80 mass % or less, more preferably 0.5 mass % or more and 70 mass % or less, further preferably 1 mass % or more and 60 mass % or less, yet further preferably 2 mass % or more and 50 mass % or less. The amount of the herbicidal active salt herein refers to an amount as the acid equivalent of the herbicidal active salt unless otherwise specified.

The herbicidal active salt concentration in the pesticidal composition is usually 0.1 mol/L or higher and 5 mol/L or lower, preferably 0.2 mol/L or higher and 4.5 mol/L or lower, more preferably 0.3 mol/L or higher and 4 mol/L or lower, further preferably 0.4 mol/L or higher and 3.5 mol/L or lower, yet further preferably 0.5 mol/L or higher and 3 mol/L or lower. The herbicidal active salt concentration in the pesticidal composition herein is a value (mol/L) obtained by dividing a molar number (mol) by the volume (L) of the pesticidal composition. The molar number is obtained by dividing the weight of the herbicidal active salt contained in the pesticidal composition by the molecular weight of the herbicidal active salt.

The content of the herbicidal active salt relative to the content of the compound (I) is usually 1 time by mass or more and 100 times by mass or less, preferably 2 times by mass or more and 90 times by mass or less, more preferably 3 times by mass or more and 80 times by mass or less, further preferably 4 times by mass or more and 70 times by mass or less, furthermore preferably 5 times by mass or more and 60 times by mass or less.

The pesticidal composition may contain a pesticidal active compound other than the compound (I) and the herbicidal active salt. Examples of the pesticidal active compound other than the compound (I) and the herbicidal active salt include, but are not particularly limited to, insecticidal active ingredients, fungicidal active ingredients, herbicidal active ingredients, plant growth regulatory active ingredients and safener active ingredients. The pesticidal composition can contain one or more pesticidal active ingredients selected from the group consisting of insecticidal active ingredients, fungicidal active ingredients, herbicidal active ingredients, plant growth regulatory active ingredients and safener active ingredients as the pesticidal active compound other than the compound (I) and the herbicidal active salt. Each of the insecticidal active ingredient, the fungicidal active ingredient, the herbicidal active ingredient, the plant growth regulatory active ingredient and the safener active ingredient may comprise one, two, or more ingredients.

When the pesticidal composition contains a herbicidal active ingredient other than the compound (I) and the herbicidal active salt, the herbicidal active ingredient is particularly preferably flumioxazin, pyroxasulfone, flumiclorac pentyl, clethodim, lactofen, S metolachlor, metribuzin, flufenacet, nicosulfuron, rimsulfuron, acetochlor, mesotrione, isoxaflutole, chlorimuron ethyl, thifensulfuron methyl and cloransulam methyl.

With the total amount of the pesticidal active compound contained in the pesticidal composition being taken as 100 mass %, the total content of the compound (I) and the herbicidal active salt in all the pesticidal active compounds contained in the pesticidal composition is, for example, 50 mass % or more and 100 mass % or less. The content is preferably 60 mass % or more and 100 mass % or less, more preferably 80 mass % or more and 100 mass % or less, further preferably 90 mass % or more and 100 mass % or less, particularly preferably 95 mass % or more and 100 mass % or less.

[2] Organic Solvent

The pesticidal composition contains an organic solvent having a water solubility at 25° C. of 10 mass % or less. The organic solvent A is preferably an organic solvent capable of dissolving the compound (I). The pesticidal composition may contain one, two, or more organic solvents A.

The water solubility at 25° C. of the organic solvent A may be, for example, 8 mass % or less, may be 5 mass % or less, may be 3 mass % or less, and may be 1 mass % or less. It is preferable that the pesticidal composition contain the organic solvent A having water solubility within the range because the storage stability of the pesticidal composition is improved. The water solubility at 25° C. of the organic solvent A is usually 0 mass % or more and may be 10-5 mass % or more.

The water solubility at 25° C. herein refers to the solubility in water at a temperature of 25° C. and pH 7. For example, a water solubility at 25° C. of 10 mass % means that the solubility in 1 g of water at a temperature of 25° C. and pH 7 is 1×10⁻¹ g.

As the water solubility of the organic solvent, a value found in the database (Solubility Database) of International Union of Pure and Applied Chemistry (IUPAC) or National Institute of Standards and Technology (NIST) may be used. When a corresponding value is not found in the database, the water solubility of the organic solvent may be measured by determining the saturation solubility in water at a temperature of 25° C. and pH 7 by high-performance liquid chromatography.

Examples of the organic solvent A capable of dissolving the compound (I) include:

alcohols such as butanol, amyl alcohol, hexanol, heptanol, octanol, 2-ethylhexanol, cyclohexanol and benzyl alcohol;

esters such as acetic acid esters (e.g., ethyl acetate, butyl acetate, isoamyl acetate, isobornyl acetate, hexyl acetate, heptyl acetate, octyl acetate, and benzyl acetate), carbonic acid esters (e.g., diethyl carbonate and dibutyl carbonate), fatty acid esters (e.g., isopropyl myristate, methyl octanoate, methyl oleate, methyl laurate, dimethyl adipate, dibutyl adipate, didecyl adipate, tri-n-butyl citrate, di-n-butyl phthalate, methyl caprylate, methyl laurate, methyl myristate, methyl salicylate, methyl palmitate, methyl oleate, and ethyl palmitate), phthalic acid esters (e.g., dimethyl phthalate and diethyl phthalate), benzoic acid esters (e.g., methyl benzoate and ethyl benzoate), succinic acid esters (e.g., dioctyl succinate), and acetoacetic acid esters (e.g., tert-butyl acetoacetate and allyl acetoacetate);

ethers such as propylene glycol phenyl ether;

ketones such as cyclohexanone, 2-heptanone, isophorone, mesityl oxide, methyl isoamyl ketone, methyl isobutyl ketone, methylcyclohexanone, and acetophenone;

amides such as fatty acid dimethylamides (e.g., N,N-dimethyloctanamide, N,N-dimethyldecanamide, N,N-dimethyldodecanamide, N,N-dimethyltetradecanamide, and N,N-dimethyloctadecanamide), and alkylpyrrolidones (e.g., N-octyl-pyrrolidone, N-dodecyl-pyrrolidone, and N-decyl-pyrrolidone);

lactones such as γ-octanolactone and δ-octanolactone;

amines such as n-octylamine, oleylamine, and laurylamine;

aliphatic hydrocarbons such as decane, tridecane, tetradecane, hexadecane, octadecane, normal paraffin, isoparaffin, cycloparaffin, 1-undecene and 1-heneicosene;

aromatic hydrocarbons such as alkylbenzenes such as toluene, xylene, ethylbenzene, octadecylbenzene, dialkylbenzene and trialkylbenzene, alkylnaphthalenes such as methylnaphthalene, dimethylnaphthalene, dodecylnaphthalene and tridecylnaphthalene, and phenylxylylethane and 1-phenyl-1-ethylphenylethane, and a mixture of these;

fatty acids such as oleic acid, capric acid, and enanthic acid;

animal- or vegetable-derived oils such as coconut oil, olive oil, soybean oil, rapeseed oil, castor oil, linseed oil, cottonseed oil, palm oil, avocado oil, shark liver oil, sardine oil, and saury oil;

mineral oils such as naphtha, petroleum ether, kerosene, diesel oil, paraffin, olefin, and machine oil; and

silicone oil.

As the organic solvent A, a commercially available solvent may be used. Examples of the commercially available product include, in trade names, Hallcomid M-8-10 (mixture of N,N-dimethyloctanamide and N,N-dimethyldecanamide, manufactured by Stepan), Hallcomid M-10 (N,N-dimethyldecanamide, manufactured by Stepan), Hallcomid M-12 (N,N-dimethyldodecanamide, manufactured by Stepan), Hallcomid M-18 (N,N-dimethyloctadecanamide, manufactured by Stepan), Hallcomid 1025 (N,N-dimethyl-9-deceneamide, manufactured by Stepan), Rhodiasolv Iris (mixture of dimethyl 2-methylglutarate, dimethyl 2-ethylsuccinate, and dimethyl adipate, manufactured by Solvay), PURASOLV EHL (2-ethylhexyl-L-lactate, manufactured by Corbion purac), AGSOLEX 8 (N-octyl-pyrrolidone, manufactured by Ashland), AGSOLEX 12 (N-dodecyl-pyrrolidone, manufactured by Ashland), Stepan C-25 (methyl caprylate, manufactured by Stepan), Stepan C-42 (mixture of methyl laurate and methyl myristate, manufactured by Stepan), Stepan C-65 (mixture of methyl palmitate and methyl oleate, manufactured by Stepan), Dowanol PPh (propylene glycol phenyl ether, manufactured by Dow Chemical), Nisseki Hisol SAS-296 (mixture of 1-phenyl-1-xylylethane and 1-phenyl-1-ethylphenylethane, manufactured by JX Nippon Oil & Energy), SOLVESSO 100 (containing C9-C10 dialkyl- and trialkylbenzene as its main aromatic hydrocarbon, manufactured by ExxonMobil Chemical), SOLVESSO 150 (containing C10-C11 alkyl benzene as its main aromatic hydrocarbon, manufactured by ExxonMobil Chemical), SOLVESSO 150ND (containing C10-C11 alkyl benzene as its main aromatic hydrocarbon, manufactured by ExxonMobil Chemical), SOLVESSO 200 (containing C10-C13 alkyl naphthalene as its main aromatic hydrocarbon, manufactured by ExxonMobil Chemical), and SOLVESSO 200ND (containing C10-C13 alkyl naphthalene as its main aromatic hydrocarbon, manufactured by ExxonMobil Chemical).

In view of the solubility of the compound (I) and storage stability of the pesticidal composition as well as emulsion stability of the pesticidal composition when diluted, the organic solvent A preferably comprises an aromatic hydrocarbon, an aliphatic hydrocarbon, a ketone, an ester, an ether, an amide, an amine, and/or an alcohol, and more preferably comprises an aromatic hydrocarbon. Examples of the aromatic hydrocarbon preferably include alkylbenzenes such as toluene, xylene, ethylbenzene, octadecylbenzene, dialkylbenzene and trialkylbenzene, alkylnaphthalenes such as methylnaphthalene, dimethylnaphthalene, dodecylnaphthalene and tridecylnaphthalene, and phenylxylylethane and 1-phenyl-1-ethylphenylethane, and a mixture of these. The organic solvent A more preferably comprises one or more selected from the group consisting of alkylbenzenes and alkylnaphthalenes, and further preferably comprises one or more selected from the group consisting of C9-C12 alkylbenzenes and C10-C15 alkylnaphthalenes. The organic solvent A may consist of an aromatic hydrocarbon.

With the total amount of the pesticidal composition being taken as 100 mass %, the content of the organic solvent A in the pesticidal composition is preferably 0.1 mass % or more and 30 mass % or less, more preferably 0.5 mass % or more and 25 mass % or less, further preferably 1 mass % or more and 20 mass % or less, yet further preferably 3 mass % or more and 15 mass % or less.

The content of the organic solvent A relative to the content of the compound (I) is usually 1 time by mass or more and 50 times by mass or less. The content of the organic solvent A relative to the content of the compound (I) is, for example, 2 times by mass, 3 times by mass, 4 times by mass, 5 times by mass, 6 times by mass, 7 times by mass, 8 times by mass, 9 times by mass, 10 times by mass, 11 times by mass, 12 times by mass, 13 times by mass, 14 times by mass, 15 times by mass, 16 times by mass, 17 times by mass, 18 times by mass, 19 times by mass, 20 times by mass, 21 times by mass, 22 times by mass, 23 times by mass, 24 times by mass, 25 times by mass, 26 times by mass, 27 times by mass, 28 times by mass, 29 times by mass, 30 times by mass, 31 times by mass, 32 times by mass, 33 times by mass, 34 times by mass, 35 times by mass, 36 times by mass, 37 times by mass, 38 times by mass, 39 times by mass, 40 times by mass, 41 times by mass, 42 times by mass, 43 times by mass, 44 times by mass, 45 times by mass, 46 times by mass, 47 times by mass, 48 times by mass, and 49 times by mass.

When the pesticidal composition contains two or more organic solvents A, the content of the organic solvent A mentioned above is the total content of the two or more organic solvents A. The same holds true for other ingredients that the pesticidal composition contains or may contain, and the content of each ingredient is the total content of two or more ingredients, if contained, unless otherwise specified.

The pesticidal composition can contain an organic solvent other than the organic solvent A. However, for improving the storage stability of the pesticidal composition, it is preferable that the organic solvent contained in the pesticidal composition consist of the organic solvent A.

[3] Surfactant

The pesticidal composition contains one, two, or more surfactants. Examples of the surfactant include nonionic surfactants, anionic surfactants, cationic surfactants, and amphoteric surfactants. The pesticidal composition can contain one, two, or more surfactants selected from the group consisting of nonionic surfactants, anionic surfactants, cationic surfactants, and amphoteric surfactants.

Examples of the nonionic surfactant include:

block polymers such as polyoxyethylene polyoxypropylene block copolymers, and block polymers of alkanol, polyethylene oxide, and polypropylene oxide;

synthetic polymers such as vinyl acetate copolymers, polymethacrylic acid, and copolymers of methacrylic acid and methacrylic acid ester;

polyoxyalkylene fatty acid esters such as polyoxyethylene fatty acid esters (e.g., polyoxyethylene stearic acid ester), polyoxypropylene fatty acid esters (e.g., polyoxypropylene stearic acid ester) and polyoxyethylene polyoxypropylene fatty acid ester;

fatty acid esters such as fatty acid esters of polyol, monoglyceride, and phospholipids;

alcohol ethoxylates such as aliphatic alcohol ethoxylates (e.g., tridecyl alcohol ethoxylate, decyl alcohol ethoxylate, isooctyl alcohol ethoxylate, lauryl alcohol ethoxylate, hexadecyl alcohol ethoxylate, and stearyl alcohol ethoxylate), alkylphenol ethoxylates (e.g., nonylphenol ethoxylate, tristyrylphenol ethoxylate, tributylphenol ethoxylate, and octylphenol ethoxylate), arylalkylphenol ethoxylates, and arylphenol ethoxylates (e.g., monobenzylbiphenol alcohol ethoxylate);

alcohol propoxylates such as aliphatic alcohol propoxylate, alkylphenol propoxylate, and arylalkylphenol propoxylate:

polyoxyalkylene vegetable oils such as polyoxyethylene castor oil and polyoxyethylene polyoxypropylene castor oil;

polyoxyalkylene hydrogenated vegetable oils such as polyoxyethylene hydrogenated castor oil;

glycerin fatty acid esters;

glucose esters;

cellulose esters;

sucrose fatty acid esters (e.g., sucrose stearic acid diester);

sorbitan fatty acid esters such as sorbitan laurate, sorbitan stearate, sorbitan oleate and sorbitan trioleate;

polyoxyalkylene sorbitan fatty acid esters such as polyoxyethylene sorbitan laurate, polyoxyethylene sorbitan stearate, polyoxyethylene sorbitan oleate polyoxyethylene sorbitan trioleate, and polyoxyethylene polyoxypropylene sorbitan monolaurate;

fatty acid amine esters such as polyoxyethylene fatty acid amine ester and polyoxypropylene fatty acid amine ester;

polyoxyethylene rosin esters;

amides such as fatty acid alkanolamides (e.g., lauric acid diethanolamide), alkoxylated propylene oxide fatty acid glucamide, polyoxyethylene oleic acid amide, polyoxyethylene stearic acid amide, and polyvinylpyrrolidone;

amines such as alkoxylated amines (e.g., polyoxyethylene oleylamine, and α,α′-[(9-octadecenylimino)di-2,1-ethanediyl]bis(co-hydroxy)poly(oxyethylene)); and

polyvinyl alcohol.

Examples of the anionic surfactant include:

sulfonates such as alkylsulfonates (e.g., dodecylsulfonate), alpha olefin sulfonates, alkylbenzenesulfonates (e.g., decylbenzenesulfonate, dodecylbenzenesulfonate, tridecylbenzenesulfonate, and diphenylsulfonate), alkylnaphthalenesulfonates (e.g., naphthalenesulfonate, dibutylnaphthalenesulfonate, 2,2′-dinaphthylmethane-6,6′-disulfonate, diisopropylnaphthalenesulfonate, and triisopropylnaphthalenesulfonate), dialkylsulfosuccinates (e.g., sodium di(2-ethylhexyl)sulfosuccinate), N-methyl-N-acyltaurine salts (e.g., methyl oleoyl taurate), other lignin sulfonates, alkylphenolsulfonates and derivatives thereof, naphthalenesulfonate-formaldehyde condensates and derivatives thereof, and benzimidazolesulfonate derivatives;

sulfuric acid ester salts such as alkyl sulfates (e.g., n-hexyl sulfate, n-heptyl sulfate, lauryl sulfate, lauryl sulfuric acid diethanol salt, and octadecyl sulfate), polyoxyethylene alkyl ether sulfates (e.g., laureth-3-sulfate), polyoxypropylene alkyl ether sulfates, and polyoxyethylene distyryl phenyl ether sulfuric acid ester salts;

carboxylates such as fatty acid salts such as octanoate, decanoate, laurate, myristate, palmitate, stearate, behenate, and oleate, and derivatives thereof, ether carboxylates such as laureth-3-carboxylate, and derivatives thereof, N-acylsarcosine salts such as N-lauroylsarcosine salt, and derivatives thereof, N-acylglutamates such as N-lauroylglutamate, and derivatives thereof, polyacrylates, polyvinyl acetates, and polycarboxylates such as comb-shaped polymers of polyacid salts, and derivatives thereof; and

phosphoric acid ester salts such as alkyl phosphates such as lauryl phosphate, and derivatives thereof, polyoxyethylene alkyl ether phosphates and derivatives thereof, polyoxyethylene alkyl phenyl ether phosphates and derivatives thereof, and polyoxypropylene alkyl ether phosphates and derivatives thereof.

Examples of the salt in the sulfonates, the sulfuric acid ester salts, the carboxylates, and the phosphoric acid ester salts include sodium salts, potassium salts, calcium salts, ammonium salts, isopropylamine salts, and triethanolamine salts.

Examples of the cationic surfactant include:

alkylamine salts such as monomethylamine salts, dimethylamine salts, trimethylamine salts, and dodecylamine salts;

fatty acid amide amine salts such as stearamide propyldimethylamine and behenamide propyldimethylamine;

polyamine salts such as polyvinylamine and polyethyleneimine; and

alkyl quaternary ammonium salts such as lauryltrimethylammonium salt, cetyltrimethylammonium salt, dodecyltrimethylammonium salts, stearylmethylammonium salts, ethylammonium benzylbis(2-chloroethyl)bromide salts, alkyldimethylbenzylammonium salts, alkylpyridinium salts, alkylisoquinolinium salts and dialkylmorpholinium salts.

Examples of the amphoteric surfactant include

N-laurylalanine, N,N,N-trimethylaminopropionic acid, N,N,N-trihydroxyethylaminopropionic acid, N-hexyl-N,N-dimethylaminoacetic acid, betaine, alkyl betaines (e.g., 1-(2-carboxyethyl)pyrimidinium betaine), imidazoline, taurine, alkyltaurine and lecithin.

As the surfactant, a commercially available surfactant may be used.

Examples of a commercially available nonionic surfactant include, in trade names, Selvol 523 (polyvinyl alcohol, manufactured by Sekisui Specialty Chemicals), Stepflow 26F (polyoxyethylene polyoxypropylene block copolymer, manufactured by Stepan), Toximul 8323 (polyoxyethylene polyoxypropylene block copolymer, manufactured by Stepan), Atlas G5000 (butyl block copolymer, manufactured by Croda), Atlas G5002L (butyl block copolymer, manufactured by Croda), Antarox B/848 (polyoxyethylene polyoxypropylene block copolymer, manufactured by Solvay), Pegnol 24-O (polyoxyethylene fatty acid ester, manufactured by TOHO Chemical Industry), Pegnol 14-S (polyoxyethylene fatty acid ester, manufactured by TOHO Chemical Industry), Pegnol ST-7 (polyoxyethylene alkyl ether, manufactured by TOHO Chemical Industry), ATPLUS245 (polyoxyethylene polyoxypropylene alkyl ether, manufactured by Croda), Synperonic AB6 (polyoxyalkylene alkyl ether, HLB: 12, manufactured by Croda), Synperonic 13/6 (polyoxyethylene tridecyl alcohol, HLB: 11, manufactured by Croda), Synperonic 91/6 (polyoxyethylene C9-C11 alcohol, HLB: 13, manufactured by Croda), Brij 03 (polyoxyethylene oleyl ether, HLB: 7, manufactured by Croda), Genapol X060 (polyoxyethylene alkyl ether, manufactured by Clariant), Genapol X150 (polyoxyethylene alkyl ether, manufactured by Clariant), Emulsogen TS200 (polyoxyethylene tristyryl phenyl ether, manufactured by Clariant), Emulsogen TS290 (polyoxyethylene tristyryl phenyl ether, manufactured by Clariant), Emulsogen TS540 (polyoxyethylene tristyryl phenyl ether, manufactured by Clariant), Emulsogen TS600 (polyoxyethylene tristyryl phenyl ether, manufactured by Clariant), Emulsogen EL360 (polyoxyethylene castor oil, manufactured by Clariant), Emulsogen EL400 (polyoxyethylene castor oil, manufactured by Clariant), Emulsogen EL540 (polyoxyethylene castor oil, manufactured by Clariant), Solpol T26 (polyoxyethylene alkyl aryl ether, manufactured by TOHO Chemical Industry), Alkamuls OR/40 (polyoxyethylene castor oil, manufactured by Solvay), Toximul 8240 (polyoxyethylene castor oil, molar number of added EO: 36, manufactured by Stepan), Toximul 8241 (polyoxyethylene castor oil, molar number of added EO: 30, manufactured by Stepan), Toximul 8242 (polyoxyethylene castor oil, molar number of added EO: 40, manufactured by Stepan), NIKKOL HCO-20 (polyoxyethylene hydrogenated castor oil, manufactured by Nikko Chemicals), Geronol TE/250 (mixture of polyoxyethylene castor oil and polyoxyethylene polyoxypropylene monobutyl ether, manufactured by Solvay), NIKKOL MGU (glycerol fatty acid ester, manufactured by Nikko Chemicals), NIKKOL DGS-80 (glycerol fatty acid ester, manufactured by Nikko Chemicals), Newcol 20 (sorbitan laurate, manufactured by Nippon Nyukazai), Newcol 25 (polyoxyethylene sorbitan laurate, manufactured by Nippon Nyukazai), and Tween L-1010 (polyoxyethylene polyoxypropylene sorbitan monolaurate, manufactured by Croda).

Examples of a commercially available anionic surfactant include, in trade names, Rhodacal 70 (calcium dodecylbenzenesulfonate, branched, manufactured by Solvay), Rhodacal 70/B (calcium dodecylbenzenesulfonate, linear, manufactured by Solvay), Rhodacal LDS-25/AP (sodium dodecylbenzenesulfonate, linear, manufactured by Solvay), Calsogen 4814 (calcium dodecylbenzenesulfonate, manufactured by Clariant), Phenylsulfonat CAL (calcium dodecylbenzenesulfonate, manufactured by Clariant), Geropon CYA/75 (sodium di(2-ethylhexyl) sulfosuccinate, manufactured by Solvay), and Soprophor DSS/7 (polyoxyethylene distyryl phenyl ether sulfuric acid ester ammonium salt, manufactured by Solvay).

With the total amount of the pesticidal composition being taken as 100 mass %, the content of the surfactant in the pesticidal composition is preferably 1 mass % or more and 50 mass % or less, more preferably 2 mass % or more and 45 mass % or less, further preferably 3 mass % or more and 40 mass % or less, yet further preferably 4 mass % or more and 35 mass % or less, particularly preferably 5 mass % or more and 30 mass % or less.

The content of the surfactant relative to the content of the compound (I) is 10 times by mass to 50 times by mass. The content of the surfactant relative to the content of the compound (I) is, for example, 11 times by mass, 12 times by mass, 13 times by mass, 14 times by mass, 15 times by mass, 16 times by mass, 17 times by mass, 18 times by mass, 19 times by mass, 20 times by mass, 21 times by mass, 22 times by mass, 23 times by mass, 24 times by mass, 25 times by mass, 26 times by mass, 27 times by mass, 28 times by mass, 29 times by mass, 30 times by mass, 31 times by mass, 32 times by mass, 33 times by mass, 34 times by mass, 35 times by mass, 36 times by mass, 37 times by mass, 38 times by mass, 39 times by mass, 40 times by mass, 41 times by mass, 42 times by mass, 43 times by mass, 44 times by mass, 45 times by mass, 46 times by mass, 47 times by mass, 48 times by mass, and 49 times by mass.

The content of the surfactant relative to the total sum of the content of the compound (I) and the content of the organic solvent A is usually 0.2 times by mass or more and 25 times by mass or less. The content of the surfactant relative to the total sum of the content of the compound (I) and the content of the organic solvent A is, for example, 0.4 times by mass, 0.6 times by mass, 0.8 times by mass, 1.0 time by mass, 1.2 times by mass, 1.4 times by mass, 1.6 times by mass, 1.8 times by mass, 2.0 times by mass, 2.2 times by mass, 2.4 times by mass, 2.6 times by mass, 2.8 times by mass, 3.0 times by mass, 3.2 times by mass, 3.4 times by mass, 3.6 times by mass, 3.8 times by mass, 4.0 times by mass, 4.2 times by mass, 4.4 times by mass, 4.6 times by mass, 4.8 times by mass, 5 times by mass, 6 times by mass, 7 times by mass, 8 times by mass, 9 times by mass, 10 times by mass, 11 times by mass, 12 times by mass, 13 times by mass, 14 times by mass, 15 times by mass, 16 times by mass, 17 times by mass, 18 times by mass, 19 times by mass, 20 times by mass, 21 times by mass, 22 times by mass, 23 times by mass, and 24 times by mass.

The total sum of the content of the surfactant and the content of the herbicidal active salt (here, an amount as the salt equivalent of the herbicidal active salt) relative to the total sum of the content of the compound (I) and the content of the organic solvent A is usually 0.2 times by mass or more and 100 times by mass or less. The total sum of the content of the surfactant and the content (salt equivalent) of the herbicidal active salt relative to the total sum of the content of the compound (I) and the content of the organic solvent A is, for example, 0.4 times by mass, 0.6 times by mass, 0.8 times by mass, 1.0 time by mass, 1.2 times by mass, 1.4 times by mass, 1.6 times by mass, 1.8 times by mass, 2.0 times by mass, 2.2 times by mass, 2.4 times by mass, 2.6 times by mass, 2.8 times by mass, 3.0 times by mass, 3.2 times by mass, 3.4 times by mass, 3.6 times by mass, 3.8 times by mass, 4.0 times by mass, 4.2 times by mass, 4.4 times by mass, 4.6 times by mass, 4.8 times by mass, 5.0 times by mass, 5.2 times by mass, 5.4 times by mass, 5.6 times by mass, 5.8 times by mass, 6.0 times by mass, 6.2 times by mass, 6.4 times by mass, 6.6 times by mass, 6.8 times by mass, 7.0 times by mass, 7.2 times by mass, 7.4 times by mass, 7.6 times by mass, 7.8 times by mass, 8.0 times by mass, 10 times by mass, 12 times by mass, 14 times by mass, 16 times by mass, 18 times by mass, 20 times by mass, 22 times by mass, 24 times by mass, 26 times by mass, 28 times by mass, 30 times by mass, 32 times by mass, 34 times by mass, 36 times by mass, 38 times by mass, 40 times by mass, 42 times by mass, 44 times by mass, 46 times by mass, 48 times by mass, 50 times by mass, 55 times by mass, 60 times by mass, 65 times by mass, 70 times by mass, 75 times by mass, 80 times by mass, 85 times by mass, 90 times by mass, 95 times by mass, and 99 times by mass.

It is preferable that the surfactant contained in the pesticidal composition comprise at least one nonionic surfactant.

[4] Water

The pesticidal composition contains water. Examples of the water include ion-exchange water, tap water and groundwater. The water constitutes the aqueous phase of the pesticidal composition.

With the total amount of the pesticidal composition being taken as 100 mass %, the content of the water in the pesticidal composition is preferably 30 mass % or more and 99 mass % or less, more preferably 40 mass % or more and 95 mass % or less, further preferably 45 mass % or more and 90 mass % or less, yet further preferably 50 mass % or more and 90 mass % or less.

[5] Other Ingredients

The pesticidal composition may contain a formulation aid. Examples of other formulation aids include thickeners, antifoaming agents, antifreezing agents, and antiseptics.

Examples of the thickener include polysaccharides such as xanthan gum, clay, and silicates. With the total amount of the pesticidal composition being taken as 100 mass %, the content of the thickener in the pesticidal composition is usually 0.05 mass % or more and may be 0.07 mass % or more, and is usually 5 mass % or less and may be 3 mass % or less.

Examples of the antifoaming agent include silicone-based antifoaming agents. With the total amount of the pesticidal composition being taken as 100 mass %, the content of the antifoaming agent in the pesticidal composition is usually 0.01 mass % or more and may be 0.05 mass % or more, and is usually 1 mass % or less and may be 0.5 mass % or less.

Examples of the antifreezing agent include ethylene glycol, propylene glycol, urea, and glycerin. With the total amount of the pesticidal composition being taken as 100 mass %, the content of the antifreezing agent in the pesticidal composition is usually 1 mass % or more and may be 2 mass % or more, and is usually 10 mass % or less and may be 8 mass % or less.

Examples of the antiseptic include isothiazolinone-based antiseptics. With the total amount of the pesticidal composition being taken as 100 mass %, the content of the antiseptic in the pesticidal composition is usually 0.05 mass % or more and may be 0.1 mass % or more, and is usually 0.5 mass % or less and may be 0.3 mass % or less.

[6] Volume Median Diameter of Oil Phase Particle

The pesticidal composition is an oil-in-water microemulsion containing an aqueous phase and particles of an oil phase solubilized in a micelle of a surfactant (also called swollen micelle), the particles being dispersed in the aqueous phase. In the pesticidal composition, the volume median diameter of the oil phase particles is usually 0.1 nm or larger and smaller than 100 nm, preferably 1 nm or larger and smaller than 100 nm. Examples of the volume median diameter of the oil phase particles in the pesticidal composition include 0.2 nm, 0.3 nm, 0.4 nm, 0.5 nm, 0.6 nm, 0.7 nm, 0.8 nm, 0.9 nm, 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, 30 nm, 31 nm, 32 nm, 33 nm, 34 nm, 35 nm, 36 nm, 37 nm, 38 nm, 39 nm, 40 nm, 41 nm, 42 nm, 43 nm, 44 nm, 45 nm, 46 nm, 47 nm, 48 nm, 49 nm, 50 nm, 51 nm, 52 nm, 53 nm, 54 nm, 55 nm, 56 nm, 57 nm, 58 nm, 59 nm, 60 nm, 61 nm, 62 nm, 63 nm, 64 nm, 65 nm, 66 nm, 67 nm, 68 nm, 69 nm, 70 nm, 71 nm, 72 nm, 73 nm, 74 nm, 75 nm, 76 nm, 77 nm, 78 nm, 79 nm, 80 nm, 81 nm, 82 nm, 83 nm, 84 nm, 85 nm, 86 nm, 87 nm, 88 nm, 89 nm, 90 nm, 91 nm, 92 nm, 93 nm, 94 nm, 95 nm, 96 nm, 97 nm, 98 nm, and 99 nm. The volume median diameter of the oil phase particles falls within the range, whereby a pesticidal composition excellent in herbicidal effect can be provided. The volume median diameter herein refers to a particle diameter at which a cumulative frequency becomes 50% in a particle size distribution. The volume median diameter of the oil phase particles in the pesticidal composition is measured using a particle size distribution measurement apparatus based on a dynamic light scattering method as measurement principles. As such a particle size distribution measurement apparatus, Zetasizer nano zsp (manufactured by Malvern Panalytical) can be used.

The pesticidal composition exhibits good emulsion stability (i.e. precipitation or phase separation, which may be responsible for uneven spraying, does not occur over an expected time period from dilution to spraying) when diluted with water, good compatibility (i.e. there is no occurrence of precipitates that may cause nozzle blockage) when mixed with a tank-mix partner such as other pesticidal formulations and adjuvants, good pourability from containers, and good physical stability (i.e. there is no or a little time-dependent occurrence of precipitation or caking, crystal growth, phase separation, change in color, or change in transmittance) and good chemical stability (i.e. there is no or a little time-dependent degradation of the compound (I) and the herbicidal active salt) when stored at low temperatures and/or in high-temperature environments.

For the pesticidal composition, the time required for a surface tension at 20° C. measured by a maximum bubble pressure method of a liquid that is the pesticidal composition diluted with water (0.01 mass % as a concentration of the compound (I)) to decrease from 72.80 mN/m to 52.80 mN/m (hereinafter, called T₂₀) is, for example, 500 ms or less, 400 ms or less, 350 ms or less, 300 ms or less, 250 ms or less, 200 ms or less, 170 ms or less, 140 ms or less, 120 ms or less, 100 ms or less, 85 ms or less, 70 ms or less, 60 ms or less, 50 ms or less, 40 ms or less, 35 ms or less, 30 ms or less, 25 ms or less, 20 ms or less, 17 ms or less, 14 ms or less, 12 ms or less or 10 ms or less. T₂₀ is 500 ms or less, whereby a pesticidal composition excellent in herbicidal effect can be provided. T₂₀ can be shortened by, for example, using a surfactant having a short hydrophobic chain, increasing the amount of the surfactant added, using a highly polar organic solvent, or increasing the amount of the solvent added. T₂₀ is measured using a surface tension measurement apparatus based on a maximum bubble pressure method as measurement principles. As such a surface tension measurement apparatus, automatic dynamic surface tensiometer BP-D5 (manufactured by Kyowa Interface Science Co., Ltd.) can be used. T₂₀ can also be translated into a lifetime (ms) when the surface tension measured by the maximum bubble pressure method is 52.80 mN/m. The lifetime means a time for a pressure within an air bubble generated through a capillary to reach the maximum.

[7] Method for Producing Pesticidal Composition

The pesticidal composition can be produced by a typical method for producing a microemulsion formulation in the pesticidal field. In the following, an illustrative description will be given of a method for producing the pesticidal composition, though the method for producing the pesticidal composition is not limited by these examples.

The compound (I), the organic solvent A and the surfactant are mixed to prepare an oil phase. The herbicidal active salt, water and an optional formulation aid are added to prepare an aqueous phase. The oil phase is added to the aqueous phase and mixed using a stirrer, and the resultant is mixed with an optional formulation aid such as a thickener, an antiseptic, and an antifoaming agent to obtain a pesticidal composition.

The compound (I) and the organic solvent A are mixed to prepare an oil phase. The herbicidal active salt, the surfactant, water and an optional formulation aid are added to prepare an aqueous phase. The oil phase is added to the aqueous phase and mixed using a stirrer, and the resultant is mixed with an optional formulation aid such as a thickener, an antiseptic, and an antifoaming agent to obtain a pesticidal composition.

The compound (I), the organic solvent A and the surfactant are mixed to prepare an oil phase. The herbicidal active salt, water and an optional formulation aid are added to prepare an aqueous phase. The aqueous phase is added to the oil phase and mixed using a stirrer, and the resultant is mixed with an optional formulation aid such as a thickener, an antiseptic, and an antifoaming agent to obtain a pesticidal composition.

The compound (I) and the organic solvent A are mixed to prepare an oil phase. The herbicidal active salt, the surfactant, water and an optional formulation aid are added to prepare an aqueous phase. The aqueous phase is added to the oil phase and mixed using a stirrer, and the resultant is mixed with an optional formulation aid such as a thickener, an antiseptic, and an antifoaming agent to obtain a pesticidal composition.

[8] Use of Pesticidal Composition

The pesticidal composition can be suitably used as a microemulsion formulation in the pesticidal field.

The pesticidal composition can be used in crop lands such as dry fields, orchard fields, pastures, lawn fields, and forestry fields; and non-crop lands such as levee slopes, riverbeds, shoulders and slopes of the roads, railroads, parks and green spaces, playgrounds, automobile parks, airports, and industrial plant sites such as factories and storage facilities as well as idle fields and urban deserts, thereby controlling weeds.

Examples of the plant that may be used in the pesticidal composition include the following:

crops; corn (dent corn, flint corn, flour corn, pop corn, waxy corn, sweet corn, and field corn), rice (long-grain rice, short-grain rice, medium-grain rice, Japonica rice, tropical Japonica rice, Indica rice, Javanica rice, paddy-field rice, dry rice, floating rice, direct-seeded rice, transplanted rice, and sticky rice), wheat (bread wheat (hard wheat, soft wheat, medium wheat, red wheat, and white wheat), durum wheat, spelt wheat, club wheat, and their respective winter wheat types and spring wheat types), barley (two-rowed barley (=beer barley), six-rowed barley, naked barley, pearl barley, and their respective winter barley types and spring barley types), rye (winter rye types and spring rye types), triticale (winter triticale types and spring triticale types), common oat (winter common oat types and spring common oat types), sorghum, cotton (upland cotton and pima cotton), soybean (ripe seed harvest varieties, green soybean varieties, early harvest varieties, and their respective indeterminate growth types, determinate growth types, and semi-determinate growth types), ground pea (peanut), French bean (common bean), lima bean, adzuki bean, black-eyed pea, mung bean, black gram, runner bean, ricebean, moth bean, tepary bean, broad bean, pea, chickpea, lentil, lupin, pigeon pea, alfalfa, buckwheat, sugar beet (for sugar production, for feed, root vegetables, leaf vegetables, and fuel), rape (winter rape types and spring rape types), canola (winter canola types and spring canola types), sunflower (for oil expression, edible, and for appreciation), sugar cane, tobacco, teat tree, mulberry, etc.

vegetables; Solanaceae vegetables (eggplant, tomato, green pepper, chili pepper, bell pepper, potato, etc.), Cucurbitaceae vegetables (cucumber, pumpkin, zucchini, watermelon, melon, squash, etc.), Cruciferous vegetables (radish, turnip, horseradish, kohlrabi, Chinese cabbage, cabbage, mustard, broccoli, cauliflower, etc.), Asteraceae vegetables (burdock, crown daisy, artichoke, lettuce, etc.), Liliaceae vegetables (Welsh onion, onion, garlic, asparagus, etc.), Umbelliferae vegetables (carrot, parsley, celery, parsnip, etc.), Chenopodiaceae vegetables (spinach, beet, etc.), Lamiaceae vegetables (perilla, mint, basil, lavender, etc.), strawberry, sweet potato, yam, eddo, etc.

Orchards; pomaceous fruits (apple, pear, Japanese pear, Chinese pear, Chinese quince, quince, etc.), stone fruits (peach, plum, nectarine, Japanese apricot, yellow peach, apricot, prune, etc.), citrus fruits (citrus unshiu, orange, lemon, lime, grapefruit, etc.), nut trees (chestnut, walnut, hazelnut, almond, pistachio, cashew nut, macadamia nut, etc.), berry fruits (blueberry, cranberry, blackberry, raspberry, etc.), grape, persimmon, fig, olive, loquat, banana, coffee, date, coconut, etc.

ornamental plants; flowering trees and shrubs, street trees (ash tree, birch, dogwood, eucalyptus, ginkgo (Ginkgo biloba), lilac, maple tree, oak (Quercus), poplar, cercis, Formosa gum (Liquidambar formosana), plane tree, zelkova, Japanese arborvitae (Thuja standishii), Japanese fir, hemlock, juniper, pinus, spruce, yew (Taxus cuspidate)), flowers, foliage plants, and lawn grass.

The plants are not limited as long as they are varieties that are generally cultivated.

Examples of the control target of the pesticidal composition include, but are not limited to, the following:

Urticaceae weeds: small nettle (Urtica urens)

Polygonaceae weeds: black bindweed (Polygonum convolvulus), pale persicaria (Polygonum lapathifolium), Pennsylvania smartweed (Polygonum pensylvanicum), redshank (Polygonum persicaria), bristly lady's-thumb (Polygonum longisetum), knotgrass (Polygonum aviculare), equal-leaved knotgrass (Polygonum arenastrum), Japanese knotweed (Polygonum cuspidatum), Japanese dock (Rumex japonicus), curly dock (Rumex crispus), blunt-leaved dock (Rumex obtusifolius), and common sorrel (Rumex acetosa)

Portulacaceae weeds: common purslane (Portulaca oleracea)

Caryophyllaceae weeds: common chickweed (Stellaria media), water chickweed (Stellaria aquatica), common mouse-ear (Cerastium holosteoides), sticky mouse-ear (Cerastium glomeratum), corn spurrey (Spergula arvensis), and five-wound catchfly (Silene gallica)

Molluginaceae weeds: carpetweed (Mollugo verticillata)

Chenopodiaceae weeds: common lambsquarters (Chenopodium album), Indian goosefoot (Chenopodium ambrosioides), kochia (Kochia scoparia), spiny saltwort (Salsola kali), and Orach (Atriplex spp.)

Amaranthaceae weeds: redroot pigweed (Amaranthus retroflexus), slender amaranth (Amaranthus viridis), livid amaranth (Amaranthus lividus), spiny amaranth (Amaranthus spinosus), smooth pigweed (Amaranthus hybridus), Palmer amaranth (Amaranthus palmeri), green pigweed (Amaranthus patulus), waterhemp (Amaranthus tuberculatus=Amaranthus rudis=Amaranthus tamariscinus), prostrate pigweed (Amaranthus blitoides), large-fruit amaranth (Amaranthus deflexus), mucronate amaranth (Amaranthus quitensis), alligator weed (Alternanthera philoxeroides), sessile alligator weed (Alternanthera sessilis), and perrotleaf (Alternanthera tenella)

Papaveraceae weeds: common poppy (Papaver rhoeas), field poppy (Papaver dubium), and Mexican prickle poppy (Argemone mexicana)

Brassicaceae weeds: wild radish (Raphanus raphanistrum), radish (Raphanus sativus), wild mustard (Sinapis arvensis), shepherd's purse (Capsella bursa-pastoris), white mustard (Brassica juncea), oilseed rape (Brassica napus), pinnate tansy mustard (Descurainia pinnata), marsh yellowcress (Rorippa islandica), yellow fieldcress (Rorippa sylvestris), field pennycress (Thlaspi arvense), turnip weed (Myagrum rugosum), Virginia pepperweed (Lepidium virginicum), and slender wartcress (Coronopus didymus)

Capparaceae weeds: African cabbage (Cleome affinis)

Fabaceae weeds: Indian joint vetch (Aeschynomene indica), zigzag joint vetch (Aeschynomene rudis), hemp sesbania (Sesbania exaltata), sickle pod (Cassia obtusifolia), coffee senna (Cassia occidentalis), Florida beggar weed (Desmodium tortuosum), wild groundnut (Desmodium adscendens), Illinois tick trefoil (Desmodium illinoense), white clover (Trifolium repens), kudzu (Pueraria lobata), narrowleaf vetch (Vicia angustifolia), hairy indigo (Indigofera hirsuta), Indigofera truxillensis, and common cowpea (Vigna sinensis)

Oxalidaceae weeds: creeping wood sorrel (Oxalis corniculata), European wood sorrel (Oxalis stricta), and purple shamrock (Oxalis oxyptera)

Geraniaceae weeds: Carolina geranium (Geranium carolinense) and common storksbill (Erodium cicutarium)

Euphorbiaceae weeds: sun spurge (Euphorbia helioscopia), annual spurge (Euphorbia maculata), prostrate spurge (Euphorbia humistrata), Hungarian spurge (Euphorbia esula), wild poinsettia (Euphorbia heterophylla), hyssop-leaf sandmat (Euphorbia brasiliensis), Asian copperleaf (Acalypha australis), tropic croton (Croton glandulosus), lobed croton (Croton lobatus), long-stalked phyllanthus (Phyllanthus corcovadensis), and castor bean (Ricinus communis)

Malvaceae weeds: velvetleaf (Abutilon theophrasti), arrow-leaf sida (Sida rhombifolia), heart-leaf sida (Sida cordifolia), prickly sida (Sida spinosa), Sida glaziovii, Sida santaremnensis, bladder weed (Hibiscus trionum), spurred anoda (Anoda cristata), and spine-seeded false-mallow (Malvastrum coromandelianum)

Onagraceae weeds: Ludwigia epilobioides, long-fruited primrose willow (Ludwigia octovalvis), winged water primrose (Ludwigia decurrens), common evening-primrose (Oenothera biennis), and cutleaf evening-primrose (Oenothera laciniata)

Sterculiaceae weeds: Florida waltheria (Waltheria indica)

Violaceae weeds: field violet; Viola arvensis and wild violet; Viola tricolor

Cucurbitaceae weeds: bur cucumber (Sicyos angulatus), wild cucumber (Echinocystis lobata), and bitter balsam apple (Momordica charantia)

Lythraceae weeds: Ammannia multiflora, eared redstem (Ammannia auriculata), scarlet toothcup (Ammannia coccinea), purple loosestrife (Lythrum salicaria), and Indian toothcup (Rotala indica)

Elatinaceae weeds: three-stamen waterwort (Elatine triandra) and California waterwort (Elatine californica)

Apiaceae weeds: Chinese celery (Oenanthe javanica), wild carrot (Daucus carota), and carrot fern (Conium maculatum)

Araliaceae weeds: lawn pennywort (Hydrocotyle sibthorpioides) and floating pennywort (Hydrocotyle ranunculoides)

Ceratophyllaceae weeds: common hornwort (Ceratophyllum demersum)

Cabombaceae weeds: Carolina fanwort (Cabomba caroliniana)

Haloragaceae weeds: Brazilian water milfoil (Myriophyllum aquaticum), whorled water milfoil (Myriophyllum verticillatum), and water milfoils (Myriophyllum spicatum, Myriophyllum heterophyllum, etc.)

Sapindaceae weeds: heartseed (Cardiospermum halicacabum)

Primulaceae weeds: scarlet pimpernel (Anagallis arvensis)

Asclepiadaceae weeds: common milkweed (Asclepias syriaca) and honeyvine milkweed (Ampelamus albidus)

Rubiaceae weeds: catchweed bedstraw (Galium aparine), Galium spurium var. echinospermon, broadleaf buttonweed (Spermacoce latifolia), Brazil calla lily (Richardia brasiliensis), and broadleaf buttonweed (Borreria alata)

Convolvulaceae weeds: Japanese morning glory (Ipomoea nil), ivy-leaf morning glory (Ipomoea hederacea), tall morning glory (Ipomoea purpurea), entire-leaf morning glory (Ipomoea hederacea var. integriuscula), pitted morning glory (Ipomoea lacunosa), three-lobe morning glory (Ipomoea triloba), blue morning glory (Ipomoea acuminata), scarlet morning glory (Ipomoea hederifolia), red morning glory (Ipomoea coccinea), cypress-vine morning glory (Ipomoea quamoclit), Ipomoea grandifolia, Ipomoea aristolochiaefolia, Cairo morning glory (Ipomoea cairica), field bindweed (Convolvulus arvensis), Japanese false bindweed (Calystegia hederacea), Japanese bindweed (Calystegia japonica), ivy woodrose (Merremia hederacea), hairy woodrose (Merremia aegyptia), roadside woodrose (Merremia cissoides), and small-flower morning glory (Jacquemontia tamnifolia)

Boraginaceae weeds: field forget-me-not (Myosotis arvensis)

Lamiaceae weeds: purple deadnettle (Lamium purpureum), common henbit (Lamium amplexicaule), lion's ear (Leonotis nepetaefolia), wild spikenard (Hyptis suaveolens), Hyptis lophanta, Siberian motherwort (Leonurus sibiricus), and field-nettle betony (Stachys arvensis)

Solanaceae weeds: jimsonweed (Datura stramonium), black nightshade (Solanum nigrum), American black nightshade (Solanum americanum), eastern black nightshade (Solanum ptycanthum), hairy nightshade (Solanum sarrachoides), buffalo bur (Solanum rostratum), soda-apple nightshade (Solanum aculeatissimum), sticky nightshade (Solanum sisymbriifohum), horse nettle (Solanum carolinense), cutleaf groundcherry (Physalis angulata), smooth groundcherry (Physalis subglabrata), and apple of Peru (Nicandra physalodes)

Scrophulariaceae weeds: ivyleaf speedwell (Veronica hederaefolia), common speedwell (Veronica persica), corn speedwell (Veronica arvensis), common false pimpernel (Lindernia procumbens), false pimpernel (Lindernia dubia), Lindernia angustifolia, round-leaf water hyssop (Bacopa rotundifolia), dopatrium (Dopatrium junceum), and Gratiola japonica

Plantaginaceae weeds: Asiatic plantain (Plantago asiatica), narrow-leaved plantain (Plantago lanceolata), broadleaf plantain (Plantago major), and marsh water starwort (Callitriche palustris)

Asteraceae weeds: common cocklebur (Xanthium pensylvanicum), large cocklebur (Xanthium occidentale), Canada cocklebur (Xanthium italicum), common sunflower (Helianthus annuus), wild chamomile (Matricaria chamomilla), scentless chamomile (Matricaria perforata), corn marigold (Chrysanthemum segetum), rayless mayweed (Matricaria matricarioides), Japanese mugwort (Artemisia princeps), common mugwort (Artemisia vulgaris), Chinese mugwort (Artemisia verlotorum), tall goldenrod (Solidago altissima), common dandelion (Taraxacum officinale), hairy galinsoga (Galinsoga ciliata), small-flower galinsoga (Galinsoga parviflora), common groundsel (Senecio vulgaris), flower-of-souls (Senecio brasiliensis), Senecio grisebachii, fleabane (Conyza bonariensis), Guernsey fleabane (Conyza sumatrensis), marestail (Conyza canadensis), common ragweed (Ambrosia artemisiifolia), giant ragweed (Ambrosia trifida), three-cleft bur-marigold (Bidens tripartita), hairy beggarticks (Bidens pilosa), common beggarticks (Bidens frondosa), greater beggarticks (Bidens subalternans), Canada thistle (Cirsium arvense), black thistle (Cirsium vulgare), blessed milkthistle (Silybum marianum), musk thistle (Carduus nutans), prickly lettuce (Lactuca serriola), annual sowthistle (Sonchus oleraceus), spiny sowthistle (Sonchus aspen), beach creeping oxeye (Wedelia glauca), perfoliate blackfoot (Melampodium perfoliatum), red tasselflower (Emilia sonchifolia), wild marigold (Tagetes minuta), para cress (Blainvillea latifolia), coat buttons (Tridax procumbens), Bolivian coriander (Porophyllum ruderale), Paraguay starbur (Acanthospermum australe), bristly starbur (Acanthospermum hispidum), balloon vine (Cardiospermum halicacabum), tropic ageratum (Ageratum conyzoides), common boneset (Eupatorium perfoliatum), fireweed (Erechtites hieracifolia), American cudweed (Gamochaeta spicata), linear-leaf cudweed (Gnaphalium spicatum), Jaegeria hirta, ragweed parthenium (Parthenium hysterophorus), small yellow crownbeard (Siegesbeckia orientalis), lawn burweed (Soliva sessilis), white eclipta (Eclipta prostrata), American false daisy (Eclipta alba), and spreading sneezeweed (Centipeda minima)

Alismataceae weeds: dwarf arrowhead (Sagittaria pygmaea), threeleaf arrowhead (Sagittaria trifolia), arrowhead (Sagittaria sagittifolia), giant arrowhead (Sagittaria montevidensis), Sagittaria aginashi, channelled water plantain (Alisma canaliculatum), and common water plantain (Alisma plantago-aquatica)

Limnocharitaceae weeds: Sawah flowering rush (Limnocharis flava)

Hydrocharitaceae weeds: American frogbit (Limnobium spongia), Florida elodea (Hydrilla verticillata), and common water nymph (Najas guadalupensis)

Araceae weeds: Nile cabbage (Pistia stratiotes)

Lemnaceae weeds: three-nerved duckweed (Lemna aoukikusa, Lemna paucicostata, Lemna aequinoctialis), common duckmeat (Spirodela polyrhiza), and Wolffia spp.

Potamogetonaceae weeds: roundleaf pondweed (Potamogeton distinctus) and pondweeds (Potamogeton crispus, Potamogeton illinoensis, Stuckenia pectinata, etc.)

Liliaceae weeds: wild onion (Allium canadense), wild garlic (Allium vineale), and Chinese garlic (Allium macrostemon)

Pontederiaceae weeds: common water hyacinth (Eichhornia crassipes), blue mud plantain (Heteranthera limosa), Monochoria korsakowii, and heartshape false pickerelweed (Monochoria vaginalis)

Commelinaceae weeds: common dayflower (Commelina communis), tropical spiderwort (Commelina benghalensis), erect dayflower (Commelina erecta), and Asian spiderwort (Murdannia keisak)

Poaceae weeds: common barnyardgrass (Echinochloa crus-galli), early barnyardgrass (Echinochloa oryzicola), barnyard grass (Echinochloa crus-galli var. formosensis), late watergrass (Echinochloa oryzoides), jungle rice (Echinochloa colonum), gulf cockspur (Echinochloa crus-pavonis), green foxtail (Setaria viridis), giant foxtail (Setaria faberi), yellow foxtail (Setaria glauca), knotroot foxtail (Setaria geniculata), southern crabgrass (Digitaria ciliaris), large crabgrass (Digitaria sanguinalis), Jamaican crabgrass (Digitaria horizontalis), sourgrass (Digitaria insularis), goosegrass (Eleusine indica), annual bluegrass (Poa annua), rough-stalked meadowgrass (Poa trivialis), Kentucky bluegrass (Poa pratensis), short-awn foxtail (Alopecurus aequalis), blackgrass (Alopecurus myosuroides), wild oat (Avena fatua), Johnsongrass (Sorghum halepense), shataken (grain sorghum; Sorghum vulgare), quackgrass (Agropyron repens), Italian ryegrass (Lolium multiflorum), perennial ryegrass (Lolium perenne), bomugi (rigid ryegrass; Lolium rigidum), rescue brome (Bromus catharticus), downy brome (Bromus sterilis), Japanese brome grass (Bromus japonicus), cheat (Bromus secalinus), cheatgrass (Bromus tectorum), foxtail barley (Hordeum jubatum), jointed goatgrass (Aegilops cylindrica), reed canarygrass (Phalaris arundinacea), little-seed canary grass (Phalaris minor), silky bentgrass (Apera spica-venti), fall panicum (Panicum dichotomiflorum), Texas panicum (Panicum texanum), guineagrass (Panicum maximum), broadleaf signalgrass (Brachiaria platyphylla), Congo signal grass (Brachiaria ruziziensis), Alexander grass (Brachiaria plantaginea), Surinam grass (Brachiaria decumbens), palisade grass (Brachiaria brizantha), creeping signalgrass (Brachiaria humidicola), southern sandbur (Cenchrus echinatus), field sandbur (Cenchrus pauciflorus), woolly cupgrass (Eriochloa villosa), feathery pennisetum (Pennisetum setosum), Rhodes grass (Chloris gayana), feathertop Rhodes grass (Chloris virgata), India lovegrass (Eragrostis pilosa), Natal grass (Rhynchelytrum repens), crowfoot grass (Dactyloctenium aegyptium), winkle grass (Ischaemum rugosum), swamp millet (Isachne globosa), common rice (Oryza sativa), bahiagrass (Paspalum notatum), coastal sand paspalum (Paspalum maritimum), mercergrass (Paspalum distichum), kikuyugrass (Pennisetum clandestinum), West Indies pennisetum (Pennisetum setosum), itch grass (Rottboellia cochinchinensis), Asian sprangletop (Leptochloa chinensis), salt-meadow grass (Leptochloa fascicularis), Christmas-tree grass (Leptochloa filiformis), Amazon sprangletop (Leptochloa panicoides), Japanese cutgrass (Leersia japonica), Leersia sayanuka, cutgrass (Leersia oryzoides), Glyceria leptorrhiza, sharpscale mannagrass (Glyceria acutiflora), great watergrass (Glyceria maxima), redtop (Agrostis gigantea), carpet bent (Agrostis stolonifera), Bermuda grass (Cynodon dactylon), cocksfoot (Dactylis glomerata), centipede grass (Eremochloa ophiuroides), tall fescue (Festuca arundinacea), red fescue (Festuca rubra), lalang (Imperata cylindrica), Chinese fairy grass (Miscanthus sinensis), switchgrass (Panicum virgatum), and Japanese lawngrass (Zoysia japonica)

Cyperaceae weeds: Asian flatsedge (Cyperus microiria), rice flatsedge (Cyperus iria), hedgehog cyperus (Cyperus compressus), small-flowered nutsedge (Cyperus difformis), lax-flat sedge (Cyperus flaccidus), Cyperus globosus, Cyperus nipponicus, fragrant flatsedge (Cyperus odoratus), mountain nutsedge (Cyperus serotinus), purple nutsedge (Cyperus rotundus), yellow nutsedge (Cyperus esculentus), pasture spike sedge (Kyllinga gracillima), green kyllinga (Kyllinga brevifolia), grasslike fimbristylis (Fimbristylis miliacea), annual fringerush (Fimbristylis dichotoma), slender spikerush (Eleocharis acicularis), Eleocharis kuroguwai, Japanese bulrush (Schoenoplectiella hotarui), hardstem bulrush (Schoenoplectiella juncoides), Schoenoplectiella wallichii, rough-seed bulrush (Schoenoplectiella mucronatus), Schoenoplectiella triangulatus, Schoenoplectiella nipponicus, triangular club-rush (Schoenoplectiella triqueter), Bolboschoenus koshevnikovii, and river bulrush (Bolboschoenus fluviatilis)

Equisetaceae weeds: field horsetail (Equisetum arvense) and marsh horsetail (Equisetum palustre)

Salviniaceae weeds: floating fern (Salvinia natans)

Azollaceae weeds: Japanese mosquitofern (Azolla japonica) and feathered mosquito fern (Azolla pinnata)

Marsileaceae weeds: clover fern (Marsilea quadrifolia)

Others: Filamentous algae (Pithophora, Cladophora), Bryophyta, Marchantiophyta, Anthocerotophyta, Cyanobacteria, Pteridophyta, and sucker of perennial crops (pome fruits, stone fruits, berry fruits, nuts, citrus fruits, hops, grapes, etc.)

Volunteer crops are crops escaped from crops cultivated in or before the previous year. Particularly, volunteer maze (volunteer corn) in a soy field is one of the target weeds to be controlled by the pesticidal composition.

Users prepare a dilution (spray liquid) by usually mixing the pesticidal composition with water, and apply the spray liquid from a knapsack sprayer, a spray tank, a spray plane, or an irrigation system. The amount of spray liquid differs depending on climate conditions, the timing of application, soil conditions, target crops, target weeds, etc. and is usually 10 L or more and 2000 L or less, preferably 50 L or more and 400 L or less, per hectare. Also, the spray liquid is prepared by mixing the pesticidal composition with water in usually from 2 to 10000 times, preferably from 10 to 8000 times, more preferably from 15 to 6000 times the volume of the pesticidal composition.

In applying the pesticidal composition, it may be mixed with an adjuvant. Although the type of the adjuvant is not particularly limited, it is desirable to mix an oil-based adjuvant (a mineral oil such as a paraffinic hydrocarbon, a naphthenic hydrocarbon, or an aromatic hydrocarbon, or methylated seed oil in which a vegetable oil (soybean oil or rapeseed oil) is esterified) such as Agri-Dex or MSO at 0.25%, 0.5%, 1%, 2%, 3%, 4%, 5% or 6% (volume/volume) into the spray liquid, or a nonionic adjuvant such as Induce at 0.05%, 0.1%, 0.25%, or 0.5% (volume/volume) into the spray liquid. Other examples thereof include anionic series (substituted sulfonates) such as Gramin S, cationic series (polyoxyethyleneamine) such as Genamin T 200BM, and organic silicone series such as Silwet L77. Furthermore, a drift reduction agent such as Intact (polyethylene glycol) or a volatilization-reducing agent such as Vapex, a VaporGrip Xtra Agent (mixture of potassium hydroxide and acetic acid) may be mixed. The pH or water hardness of the spray liquid is not particularly limited.

Also, in applying the pesticidal composition, a pesticidal formulation containing a pesticidal active compound other than the compound (I) may be mixed. Examples of the pesticidal formulation include, but are not particularly limited to, RoundupWeatherMax (formulation contains 660 g/L glyphosate potassium) and RoundupPowerMax (formulation contains 660 g/L glyphosate potassium).

### EXAMPLES

In the following, the present invention will be described in further detail with reference to Examples and Comparative Examples, etc. The scope of the present invention is not limited to these Examples.

The products used in the preparation of pesticidal compositions will be given below.

(Pesticidal Active Ingredient)
[1] Dicamba diglycolamine: Aqueous dicamba diglycolamine solution (aqueous solution of 40 mass % as an acid and 59 mass % as a salt; the amounts specified in Tables 1 and 2 are masses as the salt.)

(Organic Solvent)
[2] Solvesso 200ND: Containing C10-C13 alkylnaphthalene as its main aromatic hydrocarbon, manufactured by ExxonMobil Chemical

(Surfactant)
[3] Induce: Mixture of 90% of a mixture of polyoxyalkylene alkyl aryl ether, alkanolamide, dimethylsiloxane and free fatty acid, and 10% of inactive ingredients (ingredients not disclosed), manufactured by HELENA CHEMICAL COMPANY
[4] Phenylsulfonat CAL: Mixture of 70% calcium dodecylbenzenesulfonate and 30% of iso-butanol, manufactured by Clariant
[5] Emulsogen TS290: Polyoxyethylene tristyryl phenyl ether, manufactured by Clariant
[6] Atplus 245: Polyoxyethylene polyoxypropylene alkyl ether, manufactured by Croda
[7] Synperonic 13/6: polyoxyethylene tridecyl alcohol, HLB: 11, manufactured by Croda
[8] Syperonic 91/6: Polyoxyethylene C9-C11 alcohol, HLB: 13, manufactured by Croda
[9] Tween L-1010: polyoxyethylene polyoxypropylene sorbitan monolaurate, HLB: 8.8, manufactured by Croda

### Production Example 1

0.525 parts by mass of the compound (I) and 6.300 parts by mass of Induce are dissolved in 5.250 parts by mass of Solvesso 200ND to obtain an oil phase. To 12.075 parts by mass of the oil phase, 36.750 parts by mass of an aqueous dicamba diglycolamine solution (containing 21.683 parts by mass of dicamba diglycolamine) is added as an aqueous phase and mixed using Three-one-motor, and then 51.175 parts by mass of water is added and further stirred to obtain a pesticidal composition 1.

### Production Example 2

0.525 parts by mass of the compound (I) and 9.250 parts by mass of Induce are dissolved in 5.250 parts by mass of Solvesso 200ND to obtain an oil phase. To 15.025 parts by mass of the oil phase, 36.750 parts by mass of an aqueous dicamba diglycolamine solution (containing 21.683 parts by mass of dicamba diglycolamine) is added as an aqueous phase and mixed using Three-one-motor, and then 48.225 parts by mass of water is added and further stirred to obtain a pesticidal composition 2.

### Production Example 3

0.525 parts by mass of the compound (I) and 18.500 parts by mass of Induce were dissolved in 5.250 parts by mass of Solvesso 200ND to obtain an oil phase. To 24.275 parts by mass of the oil phase, 36.750 parts by mass of an aqueous dicamba diglycolamine solution (containing 21.683 parts by mass of dicamba diglycolamine) was added as an aqueous phase and mixed using Three-one-motor, and then 38.975 parts by mass of water was added and further stirred to obtain a pesticidal composition 3. The volume median diameter of pesticidal composition 3 was measured using Zetasizer nano zsp (manufactured by Malvern Panalytical). The measurement conditions are as follows: sample (refractive index: 1.520, absorptance: 0.100), dispersion medium (water, temperature: 25.0° C., viscosity: 0.8872 cP, refractive index: 1.330), measurement temperature: 25° C., equilibration time: 0 sec, cell: polystyrene DTS0012, detection angle (measurement angle: 173° backscatter), measurement time (execution time: 10 sec, the number of runs: 11 times), measurement sample preparation method; no dilution, the undiluted pesticidal composition itself was subject to measurement). The volume median diameter of the oil phase particles in pesticidal composition 3 was 4.6 nm. The specific gravity at 20° C. of pesticidal composition 3 was measured using a pycnometer. The specific gravity at 20° C. of pesticidal composition 3 was 1.1. T₂₀ of pesticidal composition 3 was measured using automatic dynamic surface tensiometer BP-D5 (manufactured by Kyowa Interface Science Co., Ltd.). The calibration conditions are as follows: calibration liquid: Elix water (specific resistance value: 15.0 MΩ·cm), liquid density: 1.000 g/cm³, surface tension: 72.80 mN/m, condition temperature: 20° C., temperature coefficient: −0.155 mN/(m·° C.), maximum lifetime: 10000 ms, water depth: 13.0 mm, sensor sensitivity: 52.49 mV/mmH₂O, offset voltage: 682.37 mV, inner diameter of a tip of a capillary (probe) for generating an air bubble: 0.3 mm. The measurement conditions are as follows: maximum lifetime: 10000 ms, liquid density: 1.000 g/cm³, water depth: 13.0 mm, sensor sensitivity: 52.49 mV/mmH₂O, offset voltage: 682.37 mV, inner diameter of the tip of the probe: 0.3 mm, surface tension of solvent at 20° C.: 72.80 mN/m, fit interval: 5 to 60000 ms, measurement sample preparation method: pesticidal composition 3 was diluted with Elix water such that the concentration of the compound (I) is 0.01 mass %, liquid temperature was adjusted to 20° C. As a result of measurement, the surface tension was 53.6 mN/m when the lifetime was 70 ms, and the surface tension was 52.4 mN/m when the lifetime was 85 ms. Specifically, T₂₀ (lifetime when the surface tension was 52.80 mN/m) of pesticidal composition 3 was more than 70 ms and less than 85 ms.

The Elix water employed water that was produced in RO-EDI pure water production apparatus Elix-Advantage-10 (manufactured by Merck Millipore) and collected through Millipak Express 40 filter (0.22 μm membrane filter).

### Production Example 4

0.525 parts by mass of the compound (I), 6.300 parts by mass of Phenylsulfonat CAL, and 6.300 parts by mass of Emulsogen TS290 are dissolved in 5.250 parts by mass of Solvesso 200ND to obtain an oil phase. To 18.375 parts by mass of the oil phase, 36.750 parts by mass of an aqueous dicamba diglycolamine solution (containing 21.683 parts by mass of dicamba diglycolamine) is added as an aqueous phase and mixed using Three-one-motor, and then 44.875 parts by mass of water is added and further stirred to obtain a pesticidal composition 4.

### Production Example 5

0.525 parts by mass of the compound (I), 7.350 parts by mass of Phenylsulfonat CAL, and 7.350 parts by mass of Emulsogen TS290 are dissolved in 5.250 parts by mass of Solvesso 200ND to obtain an oil phase. To 20.475 parts by mass of the oil phase, 36.750 parts by mass of an aqueous dicamba diglycolamine solution (containing 21.683 parts by mass of dicamba diglycolamine) is added as an aqueous phase and mixed using Three-one-motor, and then 42.775 parts by mass of water is added and further stirred to obtain a pesticidal composition 5.

### Production Example 6

0.525 parts by mass of the compound (I), 8.400 parts by mass of Phenylsulfonat CAL, and 8.400 parts by mass of Emulsogen TS290 were dissolved in 5.250 parts by mass of Solvesso 200ND to obtain an oil phase. To 22.575 parts by mass of the oil phase, 36.750 parts by mass of an aqueous dicamba diglycolamine solution (containing 21.683 parts by mass of dicamba diglycolamine) was added as an aqueous phase and mixed using Three-one-motor, and then 40.675 parts by mass of water was added and further stirred to obtain a pesticidal composition 6. The volume median diameter of pesticidal composition 6 was measured under the apparatus and measurement conditions described in Production Example 3. The volume median diameter of the oil phase particles in pesticidal composition 6 was 4.0 nm. The specific gravity at 20° C. of pesticidal composition 6 was measured by the method described in Production Example 3. The specific gravity at 20° C. of pesticidal composition 6 was 1.1. T₂₀ of pesticidal composition 6 was measured using the apparatus and the measurement conditions described in Production Example 3. As a result of measurement, the surface tension was 53.0 mN/m when the lifetime was 30 ms, and the surface tension was 51.1 mN/m when the lifetime was 35 ms. Specifically, T₂₀ (lifetime when the surface tension was 52.80 mN/m) of pesticidal composition 6 was more than 30 ms and less than 35 ms.

### Production Example 7

0.525 parts by mass of the compound (I) and 9.250 parts by mass of Atplus 245 are dissolved in 5.250 parts by mass of Solvesso 200ND to obtain an oil phase. To 15.025 parts by mass of the oil phase, 36.750 parts by mass of an aqueous dicamba diglycolamine solution (containing 21.683 parts by mass of dicamba diglycolamine) is added as an aqueous phase and mixed using Three-one-motor, and then 48.225 parts by mass of water is added and further stirred to obtain a pesticidal composition 7.

### Production Example 8

0.525 parts by mass of the compound (I) and 18.500 parts by mass of Atplus 245 are dissolved in 5.250 parts by mass of Solvesso 200ND to obtain an oil phase. To 24.275 parts by mass of the oil phase, 36.750 parts by mass of an aqueous dicamba diglycolamine solution (containing 21.683 parts by mass of dicamba diglycolamine) is added as an aqueous phase and mixed using Three-one-motor, and then 38.975 parts by mass of water is added and further stirred to obtain a pesticidal composition 8.

### Production Example 9

0.525 parts by mass of the compound (I) and 9.250 parts by mass of Synperonic 13/6 are dissolved in 5.250 parts by mass of Solvesso 200ND to obtain an oil phase. To 15.025 parts by mass of the oil phase, 36.750 parts by mass of an aqueous dicamba diglycolamine solution (containing 21.683 parts by mass of dicamba diglycolamine) is added as an aqueous phase and mixed using Three-one-motor, and then 48.225 parts by mass of water is added and further stirred to obtain a pesticidal composition 9.

### Production Example 10

0.525 parts by mass of the compound (I) and 18.500 parts by mass of Synperonic 13/6 are dissolved in 5.250 parts by mass of Solvesso 200ND to obtain an oil phase. To 24.275 parts by mass of the oil phase, 36.750 parts by mass of an aqueous dicamba diglycolamine solution (containing 21.683 parts by mass of dicamba diglycolamine) is added as an aqueous phase and mixed using Three-one-motor, and then 38.975 parts by mass of water is added and further stirred to obtain a pesticidal composition 10.

### Production Example 11

0.525 parts by mass of the compound (I) and 9.250 parts by mass of Syperonic 91/6 are dissolved in 5.250 parts by mass of Solvesso 200ND to obtain an oil phase. To 15.025 parts by mass of the oil phase, 36.750 parts by mass of an aqueous dicamba diglycolamine solution (containing 21.683 parts by mass of dicamba diglycolamine) is added as an aqueous phase and mixed using Three-one-motor, and then 48.225 parts by mass of water is added and further stirred to obtain a pesticidal composition 11.

### Production Example 12

0.525 parts by mass of the compound (I) and 18.500 parts by mass of Syperonic 91/6 are dissolved in 5.250 parts by mass of Solvesso 200ND to obtain an oil phase. To 24.275 parts by mass of the oil phase, 36.750 parts by mass of an aqueous dicamba diglycolamine solution (containing 21.683 parts by mass of dicamba diglycolamine) is added as an aqueous phase and mixed using Three-one-motor, and then 38.975 parts by mass of water is added and further stirred to obtain a pesticidal composition 12.

### Production Example 13

0.525 parts by mass of the compound (I) and 9.250 parts by mass of Tween L-1010 are dissolved in 5.250 parts by mass of Solvesso 200ND to obtain an oil phase. To 15.025 parts by mass of the oil phase, 36.750 parts by mass of an aqueous dicamba diglycolamine solution (containing 21.683 parts by mass of dicamba diglycolamine) is added as an aqueous phase and mixed using Three-one-motor, and then 48.225 parts by mass of water is added and further stirred to obtain a pesticidal composition 13.

### Production Example 14

0.525 parts by mass of the compound (I) and 18.500 parts by mass of Tween L-1010 are dissolved in 5.250 parts by mass of Solvesso 200ND to obtain an oil phase. To 24.275 parts by mass of the oil phase, 36.750 parts by mass of an aqueous dicamba diglycolamine solution (containing 21.683 parts by mass of dicamba diglycolamine) is added as an aqueous phase and mixed using Three-one-motor, and then 38.975 parts by mass of water is added and further stirred to obtain a pesticidal composition 14.

First, evaluation criteria of herbicidal efficacies and crop injuries to crops given in the following Examples will be described.

[Herbicidal Effect and Crop Injury to Crop]

In evaluation, herbicidal effects are divided into 0 to 100 such that the herbicidal effect is defined as “0” if the state of budding or growth of test weeds indicates no or little difference compared to that in the case of no treatment at the time of the investigation; and it is defined as “100” if test weeds are completely dead or the budding or growth of test weeds is completely prevented.

In evaluation, crop injuries to crops are defined as “harmless” if almost no crop injury is observed, as “small” if a mild crop injury is observed, as “medium” if a moderate crop injury is observed, and as “large” if a severe crop injury is observed.

### Test Example 1

The weeds (Palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), marestail (Conyza canadensis), common lambsquarters (Chenopodium album), kochia (Kochia scoparia), corn (supposed to be volunteer corn), common barnyardgrass (Echinochloa crus-galli), and giant foxtail (Setaria faberi)) are seeded to a plastic pot filled with soil. On the same day, the surface of soil is applied with a mixture of any one of pesticidal compositions 1 to 14, Intact (mixture of polyethylene glycol, choline chloride, and guar gum, manufactured by Precision Laboratories, specific gravity: 1.06) and water. Their respective application rate are 20 g/ha (as the compound (I)) of the pesticidal composition, and 742 g/ha of Intact, and the amount of the spray liquid is 140 L/ha. Then, they are cultivated in a greenhouse. Seven days later, soybean is seeded. Fourteen days later, a weed control effect and a crop injury to the soybean are investigated. All of pesticidal compositions 1 to 14 are confirmed to exhibit an excellent weed control effect compared to pesticidal compositions in which the weight ratio between the compound (I) and the surfactant is less than 1:10 or exceeds 1:50.

### Test Example 2

The weeds (Palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), marestail (Conyza canadensis), common lambsquarters (Chenopodium album), kochia (Kochia scoparia), corn (supposed to be volunteer corn), common barnyardgrass (Echinochloa crus-galli), and giant foxtail (Setaria faberi)) and soybean are seeded to a plastic pot filled with soil. On the same day, the surface of soil is applied with a mixture of any one of pesticidal compositions 1 to 14, Intact (mixture of polyethylene glycol, choline chloride, and guar gum, manufactured by Precision Laboratories, specific gravity: 1.06) and water. Their respective application rate are 20 g/ha (as the compound (I)) of the pesticidal composition, and 742 g/ha of Intact, and the amount of the spray liquid is 140 L/ha. Then, they are cultivated in a greenhouse, and 21 days later, a weed control effect and a crop injury to the soybean are investigated. All of pesticidal compositions 1 to 14 are confirmed to exhibit an excellent weed control effect compared to pesticidal compositions in which the weight ratio between the compound (I) and the surfactant is less than 1:10 or exceeds 1:50.

### Test Example 3

The weeds (Palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), marestail (Conyza canadensis), common lambsquarters (Chenopodium album), kochia (Kochia scoparia), corn (supposed to be volunteer corn), common barnyardgrass (Echinochloa crus-galli), and giant foxtail (Setaria faberi)) are seeded to a plastic pot filled with soil. Then, they are cultivated in a greenhouse, and 14 days later, a mixture of any one of pesticidal compositions 1 to 14, Agri-Dex (mixture of heavy paraffin oil, polyhydric alcohol fatty acid ester, and a polyethoxylate derivative, manufactured by Helena Chemical, specific gravity: 0.88), Intact (mixture of polyethylene glycol, choline chloride, and guar gum, manufactured by Precision Laboratories, specific gravity: 1.06) and water are used in foliar application. Their respective application rate are 20 g/ha (as the compound (I)) of the pesticidal composition, 1232 g/ha of Agri-Dex, and 742 g/ha of Intact, and the amount of the spray liquid is 140 L/ha. Then, they are cultivated in a greenhouse. Seven days later, soybean is seeded. Fourteen days later, a weed control effect and a crop injury to the soybean are investigated. All of pesticidal compositions 1 to 14 are confirmed to exhibit an excellent weed control effect compared to pesticidal compositions in which the weight ratio between the compound (I) and the surfactant is less than 1:10 or exceeds 1:50.

### Test Example 4

The weeds (Palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), marestail (Conyza canadensis), common lambsquarters (Chenopodium album), kochia (Kochia scoparia), corn (supposed to be volunteer corn), common barnyardgrass (Echinochloa crus-galli), and giant foxtail (Setaria faberi)) are seeded to a plastic pot filled with soil. Then, they are cultivated in a greenhouse, and 14 days later, a mixture of any one of pesticidal compositions 1 to 14, Agri-Dex (mixture of heavy paraffin oil, polyhydric alcohol fatty acid ester, and a polyethoxylate derivative, manufactured by Helena Chemical, specific gravity: 0.88), Intact (mixture of polyethylene glycol, choline chloride, and guar gum, manufactured by Precision Laboratories, specific gravity: 1.06), Vapex, a VaporGrip Xtra Agent (mixture of potassium hydroxide and acetic acid, manufactured by Kalo, specific gravity: 1.27) and water are used in foliar application. Their respective application rate are 20 g/ha (as the compound (I)) of the pesticidal composition, 1232 g/ha of Agri-Dex, 742 g/ha of Intact, and 389 g/ha of Vapex, a VaporGrip Xtra Agent, and the amount of the spray liquid is 140 L/ha. Then, they are cultivated in a greenhouse. Seven days later, soybean is seeded. Fourteen days later, a weed control effect and a crop injury to the soybean are investigated. All of pesticidal compositions 1 to 14 are confirmed to exhibit an excellent weed control effect compared to pesticidal compositions in which the weight ratio between the compound (I) and the surfactant is less than 1:10 or exceeds 1:50.

### Test Example 5

The weeds (Palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), marestail (Conyza canadensis), common lambsquarters (Chenopodium album), kochia (Kochia scoparia), corn (supposed to be volunteer corn), common barnyardgrass (Echinochloa crus-galli), and giant foxtail (Setaria faberi)) and soybean are seeded to a plastic pot filled with soil. Then, they are cultivated in a greenhouse, and 14 days later, a mixture of any one of pesticidal compositions 1 to 14, Agri-Dex (mixture of heavy paraffin oil, polyhydric alcohol fatty acid ester, and a polyethoxylate derivative, manufactured by Helena Chemical, specific gravity: 0.88), Intact (mixture of polyethylene glycol, choline chloride, and guar gum, manufactured by Precision Laboratories, specific gravity: 1.06) and water are used in foliar application. Their respective application rate are 20 g/ha (as the compound (I)) of the pesticidal composition, 1232 g/ha of Agri-Dex, and 742 g/ha of Intact, and the amount of the spray liquid is 140 L/ha. Then, they are cultivated in a greenhouse, and 21 days later, a weed control effect and a crop injury to the soybean are investigated. All of pesticidal compositions 1 to 14 are confirmed to exhibit an excellent weed control effect compared to pesticidal compositions in which the weight ratio between the compound (I) and the surfactant is less than 1:10 or exceeds 1:50.

### Test Example 6

The weeds (Palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), marestail (Conyza canadensis), common lambsquarters (Chenopodium album), kochia (Kochia scoparia), corn (supposed to be volunteer corn), common barnyardgrass (Echinochloa crus-galli), and giant foxtail (Setaria faberi)) and soybean are seeded to a plastic pot filled with soil. Then, they are cultivated in a greenhouse, and 14 days later, a mixture of any one of pesticidal compositions 1 to 14, Agri-Dex (mixture of heavy paraffin oil, polyhydric alcohol fatty acid ester, and a polyethoxylate derivative, manufactured by Helena Chemical, specific gravity: 0.88), Intact (mixture of polyethylene glycol, choline chloride, and guar gum, manufactured by Precision Laboratories, specific gravity: 1.06), Vapex, a VaporGrip Xtra Agent (mixture of potassium hydroxide and acetic acid, manufactured by Kalo, specific gravity: 1.27) and water are used in foliar application. Their respective application rate are 20 g/ha (as the compound (I)) of the pesticidal composition, 1232 g/ha of Agri-Dex, 742 g/ha of Intact, and 1858 g/ha of Vapex, a VaporGrip Xtra Agent, and the amount of the spray liquid is 140 L/ha. Then, they are cultivated in a greenhouse, and 21 days later, a weed control effect and a crop injury to the soybean are investigated. All of pesticidal compositions 1 to 14 are confirmed to exhibit an excellent weed control effect compared to pesticidal compositions in which the weight ratio between the compound (I) and the surfactant is less than 1:10 or exceeds 1:50.

### Test Examples 7 to 12

Tests are conducted under the same conditions as in Test Examples 1 to 6, respectively, except that the mixture (spray liquid) containing the pesticidal composition for use in foliar application contains RoundupWeatherMax (660 g/L glyphosate potassium, manufactured by Bayer, specific gravity: 1.36). The application rate of RoundupWeatherMax is 3180 g/ha (32 fluid ounces/acre) in terms of a formulation. All of pesticidal compositions 1 to 14 are confirmed to exhibit an 5 excellent weed control effect compared to pesticidal compositions in which the weight ratio between the compound (I) and the surfactant is less than 1:10 or exceeds 1:50.

TABLE 1

| | | Pesticidal | Pesticidal | Pesticidal | Pesticidal | Pesticidal | Pesticidal |
|---|---|---|---|---|---|---|---|
| | | composition 1 | composition 2 | composition 3 | composition 4 | composition 5 | composition 6 |
| Pesticidal active | Compound (I) | 0.525 | 0.525 | 0.525 | 0.525 | 0.525 | 0.525 |
| ingredient | Dicamba diglycolamine | 21.683 | 21.683 | 21.683 | 21.683 | 21.683 | 21.683 |
| | (salt equivalent) | | | | | | |
| Organic solvent | Solvesso 200ND | 5.250 | 5.250 | 5.250 | 5.250 | 5.250 | 5.250 |
| Surfactant | Induce | 6.300 | 9.250 | 18.500 | — | — | — |
| | Phenylsulfonat CAL | — | — | — | 6.300 | 7.350 | 8.400 |
| | Emulsogen TS290 | — | — | — | 6.300 | 7.350 | 8.400 |

| | | | | | | |
|---|---|---|---|---|---|---|
| Water | 66.242 | 63.292 | 54.042 | 59.942 | 57.842 | 55.742 |
| Total (w/w %) | 100.000 | 100.000 | 100.000 | 100.000 | 100.000 | 100.000 |

TABLE 2

| | | Pesticidal | Pesticidal | Pesticidal | Pesticidal | Pesticidal | Pesticidal | Pesticidal | Pesticidal |
|---|---|---|---|---|---|---|---|---|---|
| | | composition | composition | composition | composition | composition | composition | composition | composition |
| | | 7 | 8 | 9 | 10 | 11 | 12 | 13 | 14 |
| Pesticidal | Compound (I) | 0.525 | 0.525 | 0.525 | 0.525 | 0.525 | 0.525 | 0.525 | 0.525 |
| active | Dicamba | 21.683 | 21.683 | 21.683 | 21.683 | 21.683 | 21.683 | 21.683 | 21.683 |
| ingredient | diglycolamine | | | | | | | | |
| | (salt equivalent) | | | | | | | | |
| Organic | Solvesso | 5.250 | 5.250 | 5.250 | 5.250 | 5.250 | 5.250 | 5.250 | 5.250 |
| solvent | 200ND | | | | | | | | |
| Surfactant | Atplus 245 | 9.250 | 18.500 | — | — | — | — | — | — |
| | Synperonic 13/6 | — | — | 9.250 | 18.500 | — | — | — | — |
| | Synperonic 91/6 | — | — | — | — | 9.250 | 18.500 | — | — |
| | Tween L-1010 | — | — | — | — | — | — | 9.250 | 18.500 |

| | | | | | | | | |
|---|---|---|---|---|---|---|---|---|
| Water | 63.292 | 54.042 | 63.292 | 54.042 | 63.292 | 54.042 | 63.292 | 54.042 |
| Total (w/w %) | 100.000 | 100.000 | 100.000 | 100.000 | 100.000 | 100.000 | 100.000 | 100.000 |

1. A pesticidal composition comprising a compound represented by the formula (I), a herbicidal active salt, an organic solvent having a water solubility at 25° C. of 10 mass % or less, a surfactant and water, wherein a weight ratio between the compound represented by the formula (I) and the surfactant is 1:10 or more and 1:50 or less:

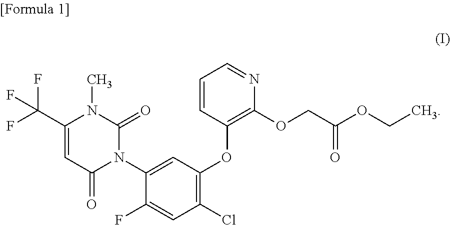 [SMILES: CCOC(=O)COc1ncccc1Oc1cc(-n2c(=O)cc(C(F)(F)F)n(C)c2=O)c(F)cc1Cl]

2. The pesticidal composition according to claim 1, wherein the surfactant comprises a nonionic surfactant.

3. The pesticidal composition according to claim 1, wherein the organic solvent comprises an aromatic hydrocarbon.

4. The pesticidal composition according to claim 1, wherein the herbicidal active salt comprises a herbicidal active carboxylate.

5. The pesticidal composition according to claim 1, wherein the herbicidal active salt comprises one or more herbicidal active salts selected from the group consisting of a herbicidal active benzoate and a herbicidal active phenoxyacetate.

6. The pesticidal composition according to claim 1, wherein the herbicidal active salt comprises one or more herbicidal active salts selected from the group consisting of a dicamba salt and a 2,4-D salt.

7. The pesticidal composition according to claim 1, wherein the herbicidal active salt comprises a dicamba salt.

8. The pesticidal composition according to claim 1, wherein the herbicidal active salt comprises dicamba diglycolamine.

9. The pesticidal composition according to claim 1, wherein the pesticidal composition contains an aqueous phase and particles of an oil phase dispersed in the aqueous phase, wherein
the oil phase contains the organic solvent and the compound represented by the formula (I) dissolved in the organic solvent.

10. The pesticidal composition according to claim 9, wherein a volume median diameter of the particles of the oil phase is 1 nm or larger and smaller than 100 nm.

11. The pesticidal composition according to claim 1, wherein T₂₀ is 500 or less, wherein
T₂₀ refers to a time (ms) required for a surface tension at 20° C. measured by a maximum bubble pressure method of a liquid that is the pesticidal composition diluted with water (0.01 mass % as a concentration of the compound represented by the formula (I)) to decrease from 72.80 mN/m to 52.80 mN/m.
